(19) United States
(12) Patent Application Publication
(10) Pub. No.: US 2008/0107793 A1
(43) Pub. Date: May 8, 2008

(54) Sheet-Form Food Containing Soybean Protein And Method Producing The Same

(76) Inventors: Yoshiaki Tanaka, Hyogo (JP); Shichiro Niwano, Hyogo (JP)

Correspondence Address: BIRCH STEWART KOLASCH & BIRCH, PO BOX 747, FALLS CHURCH, VA, 22040-0747, US

(21) Appl. No.: 11/793,136

(22) PCT Filed: Mar. 11, 2005
(86) PCT No.: PCT/JP05/04868

§ 371 Date: Jun. 14, 2007

(30) Foreign Application Priority Data
Dec. 16, 2004 (JP) 2004-365154

(51) Int. Cl. A23J 3/16; A23L 1/20; A23P 1/10

(52) U.S. Cl. 426/634; 426/517; 426/656

(57) ABSTRACT

It is intended to provide a sheet-form food containing soybean protein which contains unicellular soybean (a single cell product of soybean) as the soybean component; and a method of producing the sheet-form food containing soybean protein which comprises shaping dough containing the unicellular soybean into a sheet with the use of a drum dryer. In this food, the unicellular soybean in which soybeans are divided into single cells while remaining the cell wall is used. Since soybean cell wall remains without disruption, the odor and taste characteristic to soybean can be lessened. Moreover, this food can exert an additional effect that the useful components inherent in soybean (i.e. oil and fat, isoflavone, saponin, lecithin, dietary fiber and so on) can be used as such.

### TECHNICAL FIELD

The present invention relates to a sheet-form food containing soybean protein and a method of producing the same. More particularly, it relates to a sheet-form food that contains soybean protein and is used as dried bean curd-like food, various cooking materials and the like, and a method of producing the same.

### BACKGROUND ART

Since soybean protein is remarkably excellent in balance of essential amino acid among vegetable proteins and is high in nutritive value, high protein food that contains soybean protein as a source of protein is now studied in various ways. Also, soybean contains isoflavone having effects of suppressing arteriosclerosis or osteoporosis, which is therefore attracting attention as food that prevents such diseases. Further, soybean contains useful components such as saponin, lecithin and dietary fiber which are effective for preventing adult diseases.

As food using soybean protein, bean curd (i.e. Tofu) is most commonly known, but bean curd is extremely high in water content, and very low in the amount of protein contained per unit weight. Also, since bean curd is a coagulum of water-soluble protein extracted from soybean, it is very low in the amount of above-mentioned useful components contained in soybean.

As a sheet-form food containing soybean protein by high concentration, dried bean curd (i.e. Tofu skin, Yuba) is commonly known. Since dried bean curd is very easy to cook and is used as a material for various kinds of food. Also, it contains a great deal of fats and carbohydrate as well as soybean protein, which is therefore well-balanced nutritious food.

However, a conventional method of producing dried bean curd is very low in productivity, and waste soybean milk produced as a result of dried bean curd production is a solution containing protein in high concentration, and there arises a problem of its treatment. Also, the shelf life of raw dried bean curd is very short, and it is difficult to preserve it for a long period of time. On the other hand, dried bean curd is fragile and easy to break.

In order to solve the problem, one of the inventors studied a method of producing a sheet-form food containing soybean protein that is easy to handle, excellent in flavor, taste and nutritive balance, and in addition, capable of obtaining various foods with respect to taste and form, and is proposed a new method of producing a sheet-form food (for example, Patent Document 1).

### [Patent Document 1] Japanese Laid-Open Patent 2002-360182

The method described in the above document is a method of producing a sheet-form food containing soybean protein that is easy to handle, having a good taste, and capable of achieving the intended purpose.

However, when soybean powder is used as a raw material, the product has smell or flavor peculiar to soybean and is unable to satisfy the taste of consumers who dislike such smell or flavor. On the other hand, when refined soybean protein (for example, soybean protein isolate) is used as a raw material, the problem of smell can be solved, but there arises a problem that various useful components of soybean (i.e. isoflavone, saponin, dietary fiber) cannot be used as food.

In order to solve such problems, the inventors have further studied and found out that the above-mentioned problems can be solved by using unicellular soybean (that is, soybean enzymatically divided into a single cell product).

The present invention is based on the finding described above, and the object is to provide the sheet-form food containing soybean protein that is easy to handle and lessened in smell and taste peculiar to soybean, and in addition, capable of using useful components contained in soybean, and the method of producing the same.

### DISCLOSURE OF THE INVENTION

The present invention is intended to solve the above-mentioned problems, and the sheet-form food containing soybean protein of the present invention is a sheet-form food containing the unicellular soybean. The producing method of the present invention is a method of producing the above-mentioned sheet-form food, which is a method of producing sheet-form food containing soybean protein characterized in that dough containing the unicellular soybean is shaped into sheet by using a drum dryer. The dough is preferable to contain soybean protein and, further, preferable to contain a moisturizing agent, edible oil and fat, carbohydrate and/or dietary fiber.

### BEST MODE FOR CARRYING OUT THE INVENTION

The present invention is constituted as described above, and the unicellular soybean, main component of the sheet-form food of the present invention, is a single cell product of soybean produced by decomposing soybean by use of enzyme (such as pectinase). Such unicellular soybean is already commonly known, and for example, it can be manufactured by such a method as described in WO 01/10242. Also, the unicellular soybean is already commercially available, for example Amy-Up (trade name of Wellharmony Co., Ltd., Japan).

The unicellular soybean is a single cell product of soybean manufactured in such a method that soybean is not ground but decomposed by use of enzyme to leave cell wall or cell membrane (hereinafter called “cell wall” including both for convenience sake) of soybean as it is. Since soybean cell wall remains without disruption, smell or taste peculiar to soybean can be lessened. Also, it contains useful components of soybean such as oil, isoflavone, saponin, lecithin and dietary fiber, and at the same time, it is possible to prevent the components from being oxidized due to air.

In the sheet-form food containing the unicellular soybean as soybean protein of the present invention, the content of unicellular soybean is adjusted to about 10 to 70 wt %, preferably about 20 to 50 wt %, and more preferably about 30 to 40 wt %.

Further, when soybean protein is also contained, the total content of unicellular soybean and soybean protein in the food is adjusted to about 40 to 90 wt %, preferably about 60 to 85 wt %, and more preferably about 65 to 75 wt %.

The sheet-form food containing soybean protein of the present invention can be prepared by various methods, but it is preferable to employ the manufacturing method of the present invention.

That is, in the manufacturing method of the present invention, dough comprising at least the unicellular soybean and water is shaped into sheet by using a drum dryer.

For retaining the shape of the product sheet, soybean protein is preferable to be gelled. However, the unicellular soybean itself is poor in gelling property because soybean protein is not exposed, and therefore, to make up for the deficiency of gelling property, it is preferable to add soybean protein to the dough.

As such soybean protein, any kind of soybean protein can be used provided that it can be gelled by heating in the presence of water. For example, soybean protein isolate, soybean powder and defatted soybean can be used. Two or more kinds of these soybean proteins can be used together.

Particularly, in case of lessening smell or flavor peculiar to soybean, it is preferable to use soybean protein isolate (protein content is usually 85 to 90%) which is high in protein content, excellent in gelling property, and advantageous from the viewpoint of whiteness and odorless property. There is no particular limitation on a grain size of soybean protein isolate, and commercially available soybean protein isolate can be used. As soybean protein isolate, New FujiPro SE, R, K and V (trade names) can be exemplified.

Also, if desired to include a lot of useful components such as isoflavone, saponin, vitamins and dietary fiber inherent in soybean, it is preferable to use soybean powder. To make it pleasant to the taste, it is preferable to use a fine powder prepared by pulverizing soybean by using a grinding means such as a jet mill.

The blending ratio of unicellular soybean to soybean protein is adjusted to unicellular soybean: soybean protein=about 1:0.1 to 3 (ratio by weight, same in the following), preferably about 1:0.5 to 2.5, more preferably about 1:0.7 to 2, and still more preferably about 1:1. If the ratio of soybean protein to unicellular soybean is less than 0.1, it may cause insufficient gelling, and if the ratio exceeds 3, it may lessen the meaning of using the unicellular soybean.

The dough used in the present invention is prepared by mixing water and the unicellular soybean or a mixture of the unicellular soybean and soybean protein added as needed (hereinafter, the mixture is called soybean-based material in accordance with a conventional method.

The mixing ratio of the soybean-based material to water can be properly adjusted according to the quality and shape of the desired sheet-form food, but generally, it is adjusted to soybean-based material:water=about 1:1 to 2, preferably about 1:1.2 to 1.8, and more preferably about 1:1.4 to 1.6. If the ratio of water/soybean-based material is less than 1, the dough may become less in fluidity and poor in handling convenience, and if the ratio of water/soybean-based material exceeds 2, it may be difficult to form sheet when heated by a drum dryer.

When a paste-form material is used as the unicellular soybean, the blending amount is determined taking into account the water content thereof.

Various kinds of food components can be added to the dough as needed.

As such food components, a moisturizing agent, edible oil and fat, carbohydrates and dietary fiber can be exemplified.

It is preferable to use the moisturizing agent in order to make the food of the present invention retentive of appropriate moisture and to provide it with flexibility. As such moisturizing agent, polyoles such as glycerin, sorbitol and trehalose can be exemplified, and glycerin is especially preferable, although there is no particular limitation provided that it can be used as a food additive and can retain moisture of the food.

When the moisturizing agent is added to the dough, the amount of the moisturizing agent can be properly decided, and as against the total weight of dough, it is generally adjusted to about 1 to 20% (wt %, same in the following), preferably about 3 to 15%, and more preferably about 5 to 10%. In case the content of moisturizing agent is less than 1%, it will be difficult to obtain the effect of the moisturizing agent added, and also, 20% or less is just enough to obtain a sufficient effect, and it is not necessary to add more than that.

Edible oil and fat are added to the dough as needed in order to improve the taste and savor of the food of the present invention. As such edible oil and fat, vegetable and animal oil and fat can be used, but it is preferable to use vegetable oil and fat, because vegetable oil and fat are low in cholesterol content. As vegetable oil and fat, corn salad oil, soybean oil, rapeseed oil, cotton-seed oil, palm oil, rice bran oil, safflower oil and sesame oil are exemplified.

When edible oil and fat are added to the dough, the amount of oil and fat added can be properly decided, and as against the total weight of dough, it is generally adjusted to about 5% or less, preferably about 2%, and more preferably about 1%. If the content of edible oil and fat exceeds 5%, the obtained food will become oily, and there may cause a problem of bad taste.

Carbohydrate is added to the dough as needed in order to improve the taste and savor of the food of the present invention. As carbohydrate, starch (potato starch, corn starch, sweet potato starch, processed starch, wheat flour, rice starch, etc.), pullulan and dextrin can be exemplified, although there is no particular limitation provided that it is based on glucide.

When carbohydrate is added to the dough, the amount of the carbohydrate added can be properly decided, and as against the total weight of dough, it is generally adjusted to about 10% or less, preferably about 5%, and more preferably about 3%.

Dietary fiber is also added to the dough as needed, and any dietary fiber source can be used irrespective of being soluble or insoluble provided that the dietary fiber is eatable. For example, polydextrose (containing 90% or more dietary fiber), corn fiber [e.g. Nisshoku Selfer (trade name), containing 85% or more dietary fiber] and beat pulp that mainly consist of dietary fiber can be used.

When dietary fiber is added to the dough, the amount of the dietary fiber added can be properly decided, and as against the total weight of dough, it is generally adjusted to about 5% or less, preferably about 3%, and more preferably about 2%.

Conventional dried bean curd is less in dietary fiber content, but according to the present invention, it is possible to increase the dietary fiber content due to the unicellular soybean and dietary fiber added.

To the dough, it can be add various kinds of additives commonly used in the foodstuff industry in accordance with the desired balance of nutrition and the form of food. As such additives, seeds, seaweed, leaves, dietary fiber, fish meat, egg component and food additives can be exemplified. By adding these components, it is possible to obtain dried bean curd-like food (Yuba-like food) having good taste, flavor, and color that have been unobtainable with conventional dried bean curd, and to widen the range of application as a food material.

As seeds, sesame, macadamia nut, almond, hempseed, cashew nut, pumpkin seed, kaya seed, ginkgo nut, chestnut, walnut, coconut, pistachio, hazel nut, pine seed and peanut can be exemplified. Particularly, sesame containing vitamins and macadamia nut containing less cholesterol are preferably used. These seeds are used in the form of sliced or broken pieces.

As seaweed, hijiki seaweed, kelp, laver and wakame seaweed can be exemplified. Since seaweed contains a lot of mineral, the nutritional balance of the food can be improved by adding seaweed. In case of using seaweed, it is preferable that raw seaweed is cut into an appropriate size, and after blanching treatment (i.e. soaked in hot water for a while), subjected to drying at low temperature such as freeze-drying, then chipped or powdered. The blanching treatment is effective for vivifying and maintaining the color of seaweed, and reducing change in quality of the seaweed by inactivating thermally unstable enzymes in the seaweed.

As leaves, for example, tea leaves, green yellow vegetable leaves, mugwort, persimmon leaves, mulberry leaves and ginseng leaves can be used. Since the leaves contain various nutriments effective for maintenance of human health such as β-carotene, flavonoid, superoxide dismutase and herbal medicine, they are effective for health maintenance. Although these leaves can be added directly to the dough, it is preferable that they are subjected to low-temperature drying such as freeze-drying after blanching treatment, and chipped or powdered before using similarly to the seaweed. Further, the leaves can be used in the form of those changed into unicellular materials according to a conventional method.

Further, fish meat (including frozen food) such as codfish meat, and egg components such as egg white, egg yolk and whole egg can be added to the dough.

Also, it is preferable to properly add conventional additives to the dough, including seasonings such as salt, sodium glutamate, sodium inosinate, sodium guanylate, sugar, millet jelly, sweet oligo and oligosaccharide syrup, acidifiers such as citric acid and malic acid, thickening agent such as sodium alginate, vitamins such as vitamin A, vitamin B, vitamin C, vitamin E and vitamin K, minerals such as calcium lactate, precipitated calcium carbonate, zinc gluconate, zinc sulfate, copper gluconate and copper sulfate, herbal medicines such as Rokumigan (a kind of herbal medicine), and spices such as curry powder.

As a method for producing the dough, various methods can be employed by properly changing the mixing procedure of various kinds of materials mentioned above. For example, after adding a predetermined volume of water to a kneader, followed by slowly adding and kneading the soybean-based material, and then the moisturizing agent, edible oil and fat, carbohydrate and/or dietary fiber are slowly added and sufficiently kneaded to make uniform dough. The additives and seasonings mentioned above in can be added as needed at a proper time.

As for content of non-aqueous component (i.e. content of components other than water) in the dough, it is preferable to adjust it to about 20 to 60%, and more preferably about 40 to 50%. If the content of non-aqueous component is less than 20%, it may sometimes cause difficulty in sheet forming because of high water content, and if the content of non-aqueous component exceeds 60%, it may affect the fluidity of dough and cause poor in handling convenience.

The dough thus prepared is shaped into sheet by using a drum dryer. When the dough passes through the heated drum, it is rolled into a sheet form, and soybean protein is denatured by heat and dried with the water evaporated, thereby forming a sheet-like coat.

In the present invention, the sheet form means a flat shape that includes a film-like shape and sheet-like shape, and also a shape having a certain thickness, and it is allowable to have irregular surfaces.

The drum dryer is a conventional drying means in this field and is commonly known. As the drum dryer, any one of a single drum type, double drum type and parallel drum type can be used, but it is preferable to use the double drum dryer. Using a drum coated with fluorine resin as the drum, it is possible to prevent the sheet from being wound onto the drum.

More specifically, the double drum is previously heated by heater built-in the drum, and an appropriated distance is provided between two drums. In this condition, the dough is supplied between the drums. The dough is heated and dried in a short time, shaped into sheet and wound onto the drum, which is then removed by a knife and cut to proper sizes, and thereby, the sheet-form food of the present invention can be obtained.

As for the drum temperature, although there is no particular limitation provided that the dough can be shaped into sheet, it is generally set to about 115 to 135° C., preferably about 110 to 130° C., and more preferably to about 120 to 125° C.

The distance between drums can be properly adjusted according to the thickness and flexibility of the desired sheet-form food, but it is generally set to about 0.1 to 0.8 mm, preferably about 0.3 to 0.6 mm, and more preferably about 0.5 mm. Similarly, the drum rotating speed can be properly adjusted according to the condition of the desired sheet-form food.

The thickness of the obtained sheet-form food is not limited and can be properly adjusted according to the purpose, and it is generally set to about 0.3 to 0.6 mm.

As the drum dryer, a multi-stage dryer can be used. That is, a sheet ejected from the first drum dryer is set on the second drum dryer, and thereby, it is possible to make it uniform in thickness and to obtain a sheet having smooth surfaces.

The sheet thus obtained is food having a taste and savor similar to that of dried bean curd, and by adjusting the heating condition, water content and a kind of additive, the food can be prepared ranging from a flexible sheet to a crispy sheet, which is cut to appropriate sizes and packaged to produce a commercial product.

The water content of the sheet obtained can be properly set according to the water content of dough, heating time and the desired quality, and it is usually set to 15 wt % or less, and preferably about 10 wt %.

Since the sheet-form food of the present invention is heated and dried by a high-temperature drum dryer, the food is sterilized and can be refrigerated or frozen. Particularly, the food containing the moisturizing agent such as glycerin and trehalose can be reliably preserved for a long period of time without affecting the taste and savor.

The sheet-form food of the present invention can be widely used as a material for various kinds of food, material for Japanese cakes, healthy food having supplemental effects, preserved food and the like. For example, it is used as a material for cooked food, Yuba egg roll, Yuba shao-mai, Yuba vermicelli, fried bean curd, crust for a bun with a bean-jam filling and the like.

### INDUSTRIAL APPLICABILITY

In the sheet-form food containing soybean protein of the present invention, the unicellular soybean is contained as soybean component. The unicellular soybean is produced by dividing soybean into a single cell product with cell wall left intact, and since the cell wall of soybean are not broken, smell or flavor peculiar to soybean can be reduced, and in addition, oil, isoflavone, saponin, lecithin and dietary fiber which are useful components contained in soybean can be used as they are. Also, other nutritive components and/or food materials can be contained, and further the taste and shape can be properly changed, therefore it is possible to enhance the variety of food. Accordingly, the sheet-form food of the present invention can be widely employed as a material for various kinds of food, cakes and their material, healthy food having supplemental effects, preserved food and the like.

The method of producing the sheet-form food containing soybean protein of the present invention is a method of producing the sheet-form food, with which sheet-form food having the above-mentioned features can be easily obtained.

### EXAMPLES

The present invention will be described in detail on the basis of Examples in the following. However, the present invention is not limited to these Examples.

### Example 1

Water 550 g, glycerin 100 g, fine soybean powder 200 g and Amy-Up (trade name, unicellular soybean) 200 g were sufficiently kneaded in a kneader to obtain dough.

The dough thus obtained was put into a double drum dryer (drum set temperature: 120° C., drum interval: 0.5 mm, drum rotating speed: 0.6 rpm, drum size: 200 mm in diameter, 200 mm in length, fluorine resin coating drum), and it was passed between the drums to be shaped into sheet, thereby obtaining the sheet-form food of the present invention.

The food obtained is dried bean curd-like food having pale yellow color and flexibility, which is extremely less in smell peculiar to soybean. When cooked together with vegetables the same as for conventional dried bean curd, the food had a good taste and savor.

### Examples 2 to 6

According to the same method as in Example 1, using the materials shown in Table 1, the dough was prepared and formed by a drum dryer to obtain sheet-form food. Soybean smell of the obtained food is lessened similar to the sheet-form food obtained in Example 1.

TABLE 1

| | Example 2 | Example 3 | Example 4 | Example 5 | Example 6 |
|---|---|---|---|---|---|
| Water | 550 | 550 | 550 | 550 | 550 |
| Moisturizing | 50^{a} | 75^{a} | 100^{a} | 100^{a} | 100^{b} |
| agent | | | | | |
| Fine | 200 | 200 | 250 | 150 | 200 |
| soybean | | | | | |
| powder | | | | | |
| Amy-Up | 200 | 200 | 150 | 200 | 200 |

(Unit: g)
Moisturizing agent: ‘a’ is glycerin, and ‘b’ is trehalose.

### Example 7

According to the same method as in Example 1 except that soybean protein isolate is used instead of the fine soybean powder used in Example 1, the dough was prepared and formed by a drum dryer to obtain sheet-form food.

### Example 8

According to the same method as in Example 1 except that cod meat paste was added to the materials used in Example 1, the dough was prepared and formed by a drum dryer to obtain sheet-form food.

### Example 9

The sheet-form food obtained in Example 1 was put into a polyethylene bag, and after sealing the bag, the bag was left in a contact freezer at a temperature of −80° C. for five minutes for rapid freezing, followed by storing it in a refrigerator at a temperature of −18° C. for two weeks, and then, the appearance of the food remained unchanged. Also, after thawing the frozen sheet-form food, it was cooked the same as in Example 1, and then the food maintained good taste and savor the same as in before-freezing.

1. A sheet-form food containing soybean protein characterized in that the sheet-form food contains unicellular soybean as a soybean component.

2. The sheet-form food containing soybean protein of claim 1, wherein the food contains soybean protein as well as the unicellular soybean as soybean components.

3. A method of producing a sheet-form food containing soybean protein, wherein dough containing unicellular soybean is shaped into sheet by using a drum dryer.

4. The method of producing the sheet-form food containing soybean protein of claim 3, wherein the dough contains soybean protein.

5. The method of producing the sheet-form food containing soybean protein of claim 3, wherein the blending ratio of the unicellular soybean to soybean protein in the dough containing the unicellular soybean and soybean protein is 1:0.3 to 3 (ratio by weight).

6. The method of producing the sheet-form food containing soybean protein of any one of claims 3 to 5, wherein the dough contains a moisturizing agent, edible oil and fat, carbohydrate and/or dietary fiber.
